(19) United States
(12) Patent Application Publication
(10) Pub. No.: US 2026/0196143 A1
(43) Pub. Date: Jul. 9, 2026

(54) EDUCATIONAL SYSTEM AND PLATFORM FOR IDENTIFYING AREAS IN WHICH STUDENT IS LAGGING OR NEEDS IMPROVEMENT

(71) Applicant: Global Education Exchange Opportunities, Inc., Manati, PR (US)

(72) Inventor: Odette Piñeiro Caballero, Manati, PR (US)

(73) Assignee: Global Education Exchange Opportunities, Inc., Manati, PR (US)

(21) Appl. No.: 19/376,625

(22) Filed: Oct. 31, 2025

Related U.S. Application Data
(63) Continuation-in-part of application No. 18/089,715, filed on Dec. 28, 2022, now abandoned.
(60) Provisional application No. 63/282,131, filed on Nov. 22, 2021.

(51) Int. Cl. G09B 7/04; G06F 16/22; G06F 16/28; G09B 7/08

(52) U.S. Cl. CPC G09B 7/04; G06F 16/2246; G06F 16/288; G09B 7/08

(57) ABSTRACT

A computer-implemented educational evaluation system for assessing student mastery of hierarchical standards and sub-skills and generating automated remediation. The system includes a relational database storing a standards/skills graph, a question bank, a response store, and executable modules including a mastery inference engine, a rubric-validation module, and an instructional-content retriever. The mastery inference engine computes per-student mastery states using a deterministic algorithm that aggregates responses, applies recency weighting, and compares results to predefined thresholds. The rubric-validation module computes an item-quality score for each question based on weighted rubric criteria and automatically controls publication of low-quality items. The instructional-content retriever queries versioned mapping tables to generate machine-readable remediation plans linked to standards or sub-skills identified as not-comprehended. The system provides structured, actionable educational performance metrics and remediation outputs, implementing a technical data-processing mechanism for assessment, evaluation, and instruction.

### BACKGROUND OF THE INVENTION

Traditional education systems provide courses to students irrespective of a student's individual learning preference, ability, or predisposition. Additionally, teaching lessons are usually conducted without regard to a learner's individual learning preference, strengths, or frequency of interaction. The World Economic Forum states that, in the United States, classrooms have a student-to-teacher ratio of approximately 16:1, whereas in other countries, the same can reach 30:1. According to the Department of Education, “the lower the pupil/teacher ratio, the higher the availability of teacher services for each student.” The Condition of Education 2015, National Center for Education Statistics, U.S. Department of Education, p. 119, n.1.

However, even in low-ratio classrooms, educators struggle to continuously and accurately track every student's mastery level across hundreds of granular educational standards and sub-skills. Assessment data are often fragmented across spreadsheets, paper forms, and unstructured notes, requiring manual aggregation and subjective judgment. These traditional methods make it difficult for teachers to pinpoint, in real time, which specific skills or concepts a student or group of students have not yet mastered. Furthermore, paper-based or manually graded assessments cannot provide timely, individualized feedback or dynamically adapt lesson plans based on observed learning gaps.

Existing digital learning tools typically automate assessment delivery but fail to provide structural mechanisms to link assessment items to specific educational standards and instructional content. As a result, they remain functionally dependent on human analysis for identifying and addressing deficiencies. The lack of integrated data architecture—such as a relational database capable of mapping questions to standards and lessons, coupled with computational modules that analyze mastery levels—limits the scalability and precision of such systems.

Therefore, there exists a need for a computer-implemented educational system that provides automated, data-driven identification of learning gaps using a defined relational database structure and machine-executed analytical modules. Such a system should be capable of associating each question with a specific educational standard and sub-skill, aggregating student responses across multiple assessments, and generating individualized feedback and instructional recommendations in real time. By structuring and processing assessment data through an integrated relational model and computational inference engine, the system achieves improved consistency, precision, and response time in identifying and addressing learning deficiencies. This improvement derives from the underlying data architecture and machine-implemented processes, thereby providing a technological enhancement in how educational performance data are captured, correlated, and applied.

### SUMMARY OF THE INVENTION

The educational system and platform disclosed herein relates to a technological tool or automated process that allows an educator to identify the concept or skill in which student is lagging or needs improvement as well as providing alternatives to address them.

### BRIEF DESCRIPTION OF THE DRAWINGS

FIG. 1 Shows the user login page to access the platform.

FIG. 2 Shows the dashboard for the administrative portal the administrator will use to keep track of the services provided by the platform.

FIG. 3 Shows the school panel for the school principal of the school that is registered within the platform.

FIG. 4 Shows the professor portal.

FIG. 5 Shows the student portal.

FIG. 6 Shows the parent panel.

FIG. 7 Shows impact exams list.

FIG. 8 Shows the new exams page for the professor to create exams.

FIG. 9 Shows a drop-down list categorizing information about the exams.

FIG. 10 Shows how a professor grades and gives feedback to the student's open responses.

FIG. 11 Shows how an exam is administered to the student.

FIG. 12 Shows how the platform gives feedback to the student's closed responses.

FIG. 13 Shows a drop-down list for the multiple available reports.

FIG. 14 Shows the reports by standard for a specific unit.

FIG. 15 Shows the reports by student for a specific group.

FIG. 16 Shows the reports by unit per grade.

FIG. 17 Shows a drop-down list to toggle between sent and received messages within the platform.

FIG. 18 Shows the messages page within the platform.

FIG. 19 Shows the calendar page within the platform.

FIG. 20 Shows the instructional guides available to the professor.

FIG. 21 Shows the response processor for open responses.

FIG. 22 Shows a flowchart of the parallel processes performed by the system on the platform.

FIG. 23 Shows an example of a rubric that students can access when answering questions related to a specific topic or skill.

FIG. 24 shows an alternate embodiment of the subject disclosure.

### DETAILED DESCRIPTION OF THE INVENTION

The educational system disclosed herein relates to a technological tool or automated process that utilizes a digital platform to enable an educator, teacher, or professor to identify, within a reasonable time, the concepts or skills in which students are lagging or require improvement. This functionality allows the professor to design teaching lessons that address both the group's overall needs and individual student needs. The assessments performed by the system are aligned to educational standards, ensuring that the assessments accurately reflect what students are expected to know and be able to do. While the present system is aligned with specific educational standards, it may be adapted to any applicable standards as required.

For the purposes of the present disclosure, alignment is defined as the degree to which assessments provide valid and accurate information about the performance of all students in an academic content area at the desired level of detail on the content standards. Individual student assessment allows professors to determine student's competence in specific subject matters and allows for reteaching to ensure that all students master each lesson, especially in math where scope and sequence is crucial. Without appropriate assessment the professor lacks the tools to determine the student's growth and compliance with the standards. For example, when professors receive new students or are assigned a new grade or group at the beginning of an academic year, the professors may determine their teaching strategies based on the students'previous assessments, instead of automatically resorting to a general curriculum that might not address the particular needs of said new students. The system also allows the use of the platform in order for school administrators and professors to identify patterns related to specific groups of students (demographics, classrooms, grades, etc.) in terms of what they lack and need, progress, and effective strategies or exercises chosen by professors that have impact in achieving the desired results.

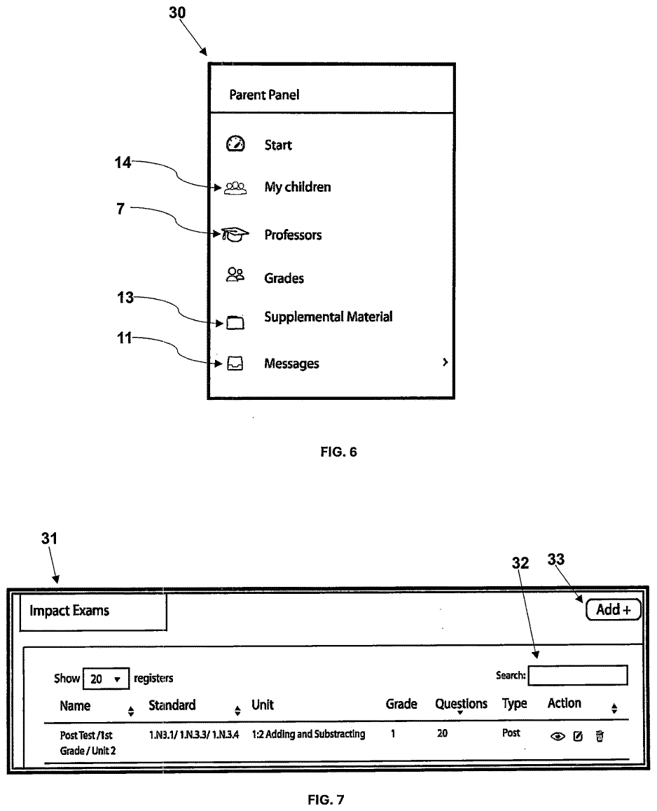

The system comprises three (3) components carried out in the platform. The first component includes a standardized test or impact exam, as shown in FIG. 7 and FIG. 11, aligned to a particular subject's standards and expectations, skills, according to a Curriculum Map. The Curriculum Map is an official document from education authorities detailing important aspects of a unit. These aspects include, but are not limited to: time frame, transfer and acquisition objectives, skills, and the unit summary concepts that the student should master by the end of the unit. This impact exam can be administered in the platform as a pre-test or post-test and the results are available immediately in the platform. This allows the professor to know the areas of lag, according to the skill, unit or concept that is being covered. Specifically, it allows the professor to measure and determine if the student has achieved mastery in a particular lesson in order to continue to the next lesson, since mastery of previous content is required in order to learn and master new content.

The tests are designed on a plugin that uses a response processor that includes text (words) and other symbols for mathematics and science, as shown in FIG. 21, allowing the integration of symbols, equations, among others, for the writing of the answers that may be required (“open responses”). By “open responses” it is meant answers that the student writes in the platform instead of answers provided by the platform from which the student chooses. The system can allow the platform to generate reports using information from the open responses to determine the most common errors committed by students. For example, a word cloud can be generated showing the words, numbers or other responses most commonly answered for an open response question. This feature allows school administrators and professors to identify patterns that can contribute to teaching opportunities by identifying effective strategies or exercises chosen by professors that have impact in achieving the desired results. For example, the word cloud can be generated by tabulating in a database all the words or numbers received in an open response, and assigning a font size to the word that is equivalent or proportional to the number of times the word is repeated in the specific open response. The results generated from these reports (e.g., word cloud) also allow the professor to identify potential wrong answers for multiple answer questions that can be used in diagnostic tests to quickly recognize learning deficiency patterns observed previously using the word cloud reporting feature. By recognizing learning deficiency patterns early, the professor can implement curriculums previously used to address the identified patterns.

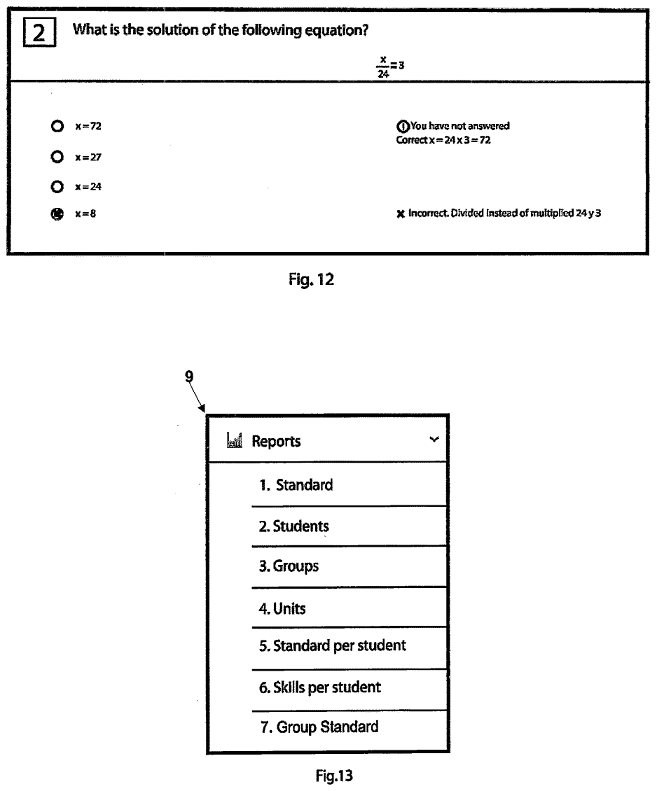

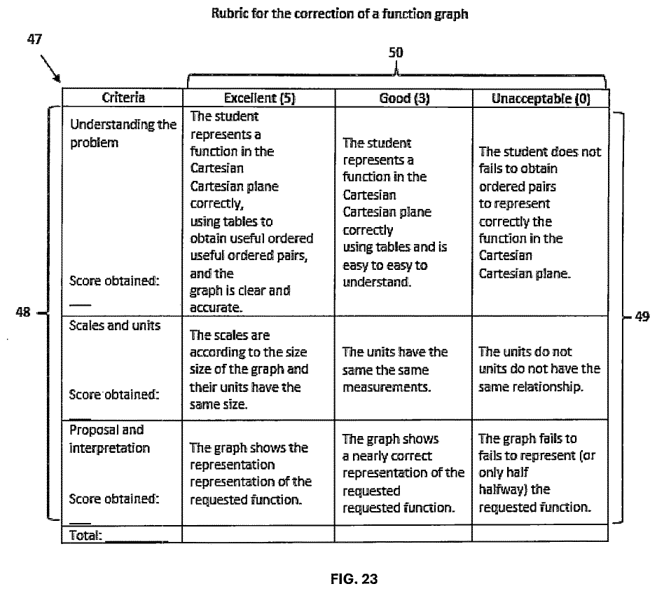

Using formative assessment to improve student performance, the system allows for the student, before submitting an open response exercise within the platform, to consider certain topics or issues that should be involved in the open response that may be lacking. This is done by comparing the students'pre-answer with a rubric (stored in a database) that includes key words or concepts that should be part of the answer. See, FIG. 23. Another way of achieving a similar result is, storing in a database, explanations for potential incorrect answers that are prompted when an incorrect answer is submitted by the student. See, FIG. 12. Through this interaction, the platform allows the student to obtain individual results and/or information regarding their performance, as well as the automated correction of conceptual errors behind the incorrect answers or items without necessarily requiring teacher interaction. This is tailored to the manner of responding of the standardized test. Moreover, the system provides for the use of the platform to create other tests to evaluate concepts, skills, standards or bench mark according to the student's needs.

As a result, the system allows the professor to use the components of the platform to identify the strong areas/skills of the students before designing a curriculum; thus, more time is devoted to lagging students and content is accelerated for those students who master it by attending to differentiated instruction in the classroom. The system further allows the platform to provide results to the professor in real time, relieving him or her of the administrative burden involved in grading papers. Results are displayed in the platform through interactive graphs so that the professor can interpret the results and easily identify the lag and/or mastery of skills by student, group and grade. The system allows for the professor to administer tests through the platform and provide results and/or information regarding the students'performance for multiple school subjects or areas of study. However, for the purposes of explaining and illustrating the functionalities of the present disclosure, Applicant includes examples related to the subject of math.

The system tracks the number of answered items, which can be displayed on the platform for the student, along with a message indicating any unanswered or missing items before test submission. During the test, students may navigate forward or backward between questions. The professor can also allow a student to restart or resume the test if it was submitted by mistake.

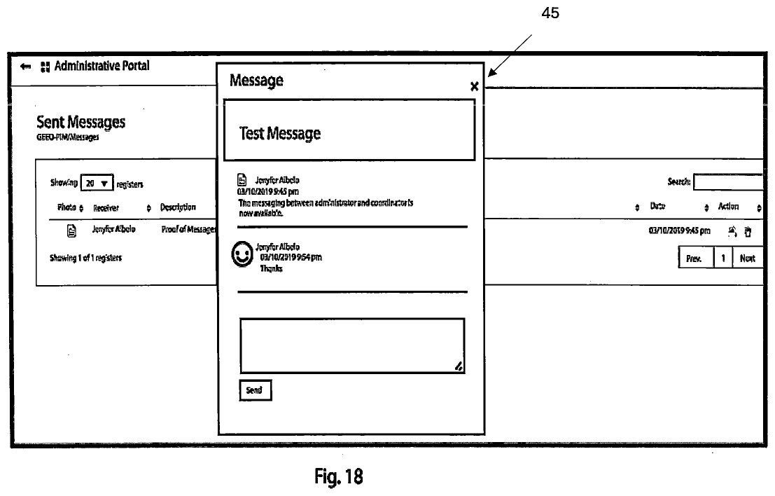

The professor may provide students and parents with complementary or study materials to support the teaching process, including videos, notebooks, audio files, links, and other resources. Internal communication is maintained through chats and messages within the platform, as illustrated in FIG. 18, enabling interactions between users such as the professor and student, professor and parents, professor and coordinator, professor and principal, principal and administrator, among others. These chats facilitate user assistance and ensure consistent communication regarding the students'learning progress. For instance, the school principal or director can view the academic performance of students in a specific subject by individual, group, or grade. Additionally, the professor can create criterion-based tests on the platform to assess student competence in real time.

Another key functionality of the system is report generation, which can be accessed and displayed through the platform (see FIGS. 13-16). These reports allow professors, school directors, and parents/guardians to monitor the performance of a student, group, or grade. Specifically, the reports identify which students have mastered a skill and which have not, enabling the detection of cognitive gaps at the individual, group, or grade level.

The system performs an automated assessment using a relational database that maps each test question to a specific standard representing a skill students must master during a lesson or unit. Upon completion of tests by all students in a group or grade, the system provides the professor with an analysis identifying the standard(s) and/or skill(s) in which students are deficient, as well as the lesson or unit that requires reinforcement to ensure mastery of the associated skill. When the system detects a pattern of incorrect answers from tests or impact exams, it uses the relational database to determine the standard and skill associated with the incorrectly answered question(s). Once identified, the system presents the professor, via the platform, with the specific standard(s) and/or skill(s) in which students, a group, or an entire grade are lagging, along with the lesson or unit that should be reinforced.

This automated assessment aggregates all incorrectly answered questions across all students who took a test or impact exam. Each question is assigned an identification number (“ID number”) in the relational database. The ID numbers corresponding to incorrectly answered questions are sorted by frequency—for example, based on the number of students who answered each question incorrectly. The system then retrieves from the relational database the standard, skill, and/or unit represented by the most frequently missed questions. This information is displayed via the platform to students, professors, and/or parents to inform them of the skills requiring improvement. The assessment can be configured to provide analyses at the level of an individual student, a group, or an entire grade. Additionally, the system can suggest strategies for reinforcing the identified skills, tailored to the specific skill and the number of students needing support. The system can also reference specific pages or sections of the workbook and instructional guide, allowing professors and students to directly address and reinforce the skills identified as needing improvement.

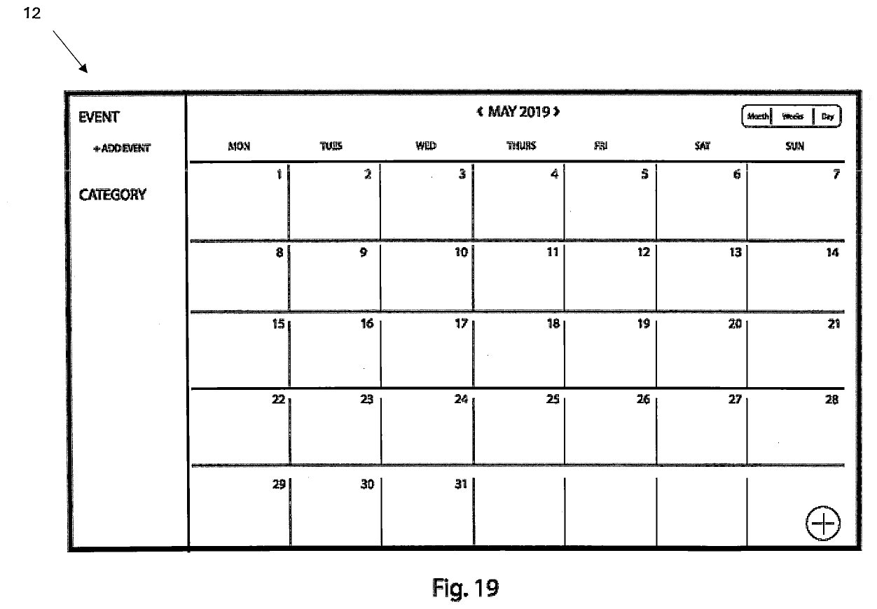

The system also includes a calendar, which can be accessed through the platform, as shown in FIG. 19, in which the users are able to view the student's upcoming tests or assessments scheduled by the professor. The students may also schedule their own study time.

In addition, the system provides different licenses for users to access the information and components within the platform. The licenses consist of different packages that the user may select from. Each license provides a different scope of access to the platform depending on the user. The system allows for the configuration of multiple users within the platform with different scopes of access and functionalities. The functionality of the platform according to some of the users that may be configured within the platform is shown below.

### Professor

1. Administration of standardized pre and post-tests of curricular content for different subjects.
2. Access to results in real time by student, group, or grade.
3. Identify lagging skills and student mastery.
4. Access to the instruction guide with explanations of the curricular contents by unit and skill.
5. Access to the student workbook.
6. Internal communication between students, professors, parents and administrative personnel. This is integral to promote the conversation around students learning process.
7. Upload to the platform of complementary material to enrich the curricular content.
8. Create criterion-referenced tests so that students can review concepts or identify whether particular student needs were met.

### Student

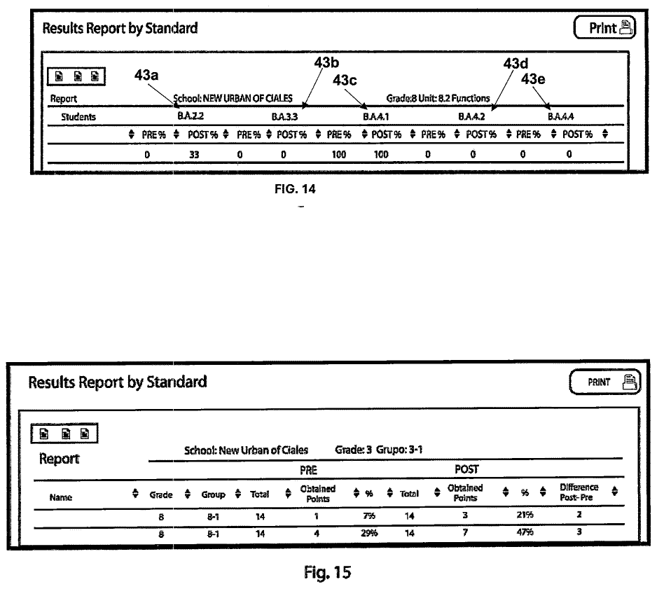

1. Respond to standardized tests in digital format. Instruction on how to analyze descriptors in an item and to develop test taking skills.
2. Access the results in real time.
3. Feedback on the answers to the answered items. When a student completes the assessment response, the student receives formative feedback to promote learning or clarification of an incorrect assumption. This means that an incorrect answer in a multiple-choice question (“closed responses”) will trigger feedback on why potentially the student chose an incorrect answer or why the answer is incorrect, and which is the correct answer and why.
4. Access to test results in real time
5. Identify the skills that are mastered and those that are not mastered. Each test item is aligned to the acquisition objectives and skills for a specific unit. The skills, in turn, are aligned to grade-level standards and indicators. Therefore, correctly answering the exercises is indicative of mastery of the skill or concept of the unit being worked on. The reporting module provides a report after a test that segregates the students'performance in comparison to the applicable standard, as shown in FIG. 14, so that the teacher can determine the cognitive gaps and prioritize corrective actions.
6. Internal communication with teachers.
7. Access to supplementary material to enrich mastery and non-mastery skills.

### Parents

1. Internal communication between teachers and administrative staff.
2. Access to results.
3. Identify mastery and non-mastery skills.
4. Access to supplementary material to enrich mastery and non-mastery skills.

### School Principal

1. Internal communication between teachers, parents and administrative staff.
2. Access to results in real time by student, group and grade, or any other classification. This can be done by incorporating the desired trait in the student or teacher profile and then generating reports based on the desired classifications. For example, the needs of limited Spanish proficient students could be analyzed through this reporting mechanism.
3. Identify the skills that are mastered and those that are not mastered.

In addition to the users defined herein, the system may also allow the configuration of other users based upon the platform's arising needs.

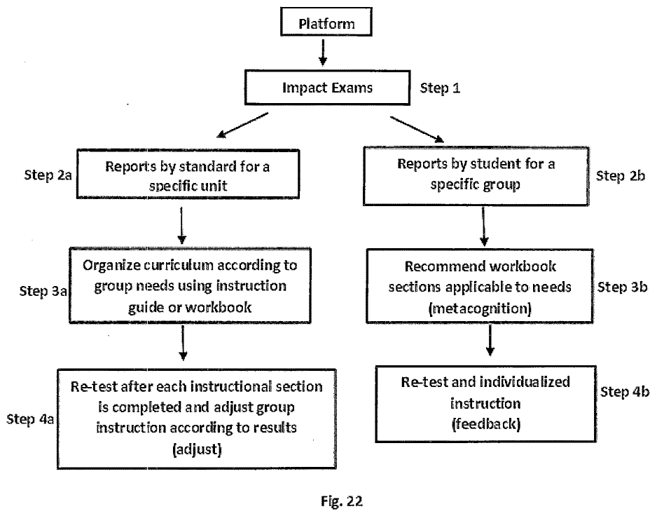

The second component is a student's workbook that allows students to practice what they have learned or continue learning at their own pace. The workbook comprises a plurality of hands-on exercises for all subjects and/or skills included by grade level and aligned with standards and expectations. The workbook avoids gaps in student's formation because it can work offline and avoid internet connectivity glitches that prevent the student from receiving the ordinary teachings offered through remote teaching tools or can even play a role during periods where the student needs to be out of the classroom due to sickness or other issues. The workbook therefore supplements the professor and can be considered a digitized teacher assistant. It also helps the professor by permitting individual work by each student to suit their specific needs, without requiring the professor's complete attention. It is a module by unit which helps the teacher guide the students to help themselves through metacognition. In this context, metacognition is related to knowing your strengths and weaknesses so that you (a student) can address them. By receiving guidance from the teacher, through the results of the impact exams, the students can understand better what skills or subjects they need to address more or more deeply. See, FIG. 22.

Finally, the third component comprises an instruction guide, which allows the professor to practice a concept or topic. It is a module by unit which helps the teacher facilitate instructions to the students. See, FIG. 22. This allows the professor to summarize or review the content using accessible language for the student. In addition, the instruction guide includes exercises with their responses; as well as the steps required to complete the exercises successfully. In this way, if a teacher is not familiar with the content or requires practice to work on a concept, the instructional guide provides it. The exams and instructional guide are accessible through the platform. The workbooks will be distributed to the students in printed format to enable students to complete the exercises included in the workbook. The instruction guide will be visible only on the platform.

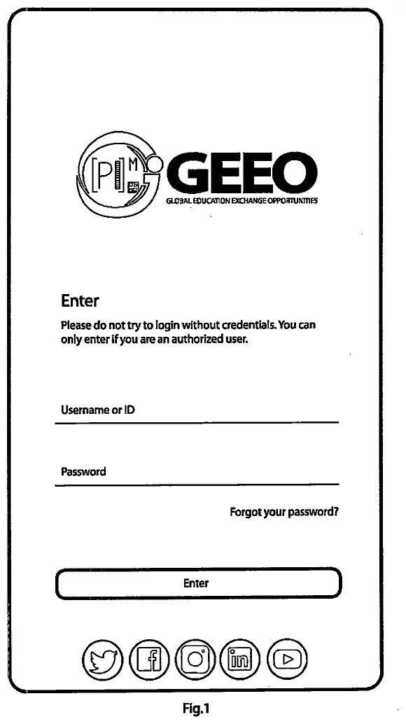

FIG. 1 Shows the user login page to access the platform. Only authorized users can log in to the platform. The platform validates the credentials inserted by the user in order to allow access to the platform.

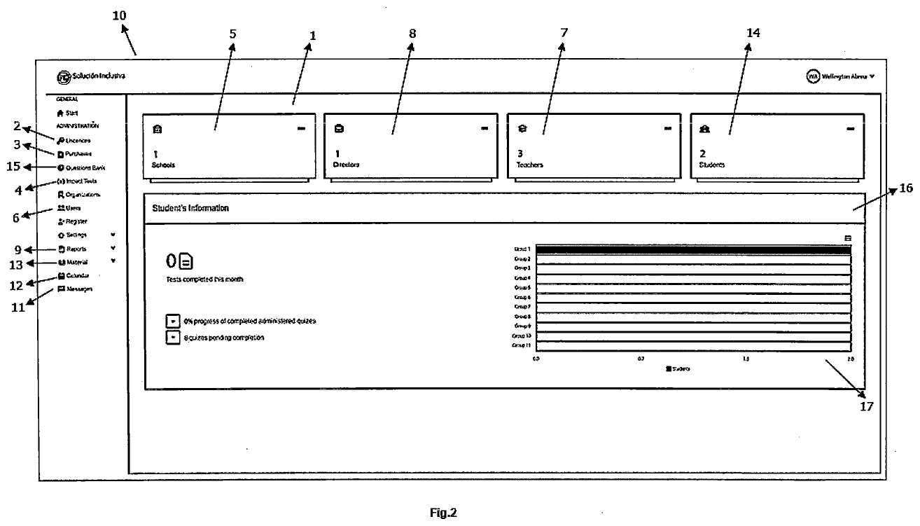

FIG. 2 Shows the dashboard 1 for the administrative portal 10 the administrator will use to keep track of the services provided by the platform. The administrator has access to the administration of licenses 2 within the platform. For example, the administrator can view and manage how many licenses have been purchased 3, the cost of each license, the access that each license provides and/or the term of each license. The administrator can view and create impact exams (Impact Tests) 4, has access to the schools 5 that are registered within the platform, users 6, professors 7, school principals (or directors) 8, reports 9, messages 11, calendar 12, study materials 13 and students 14. The administrator also has access to the question bank 15 that includes questions for the impact exams 4. The administrative portal 10 includes a students'information panel 16, which displays a graph 17 with information as to the total amount of students per group that have taken exams during the current month, the percentage of progress in the administration of tests and the number exams that are pending to be completed. The administrative portal 10 also shows the total amount of schools 5, total amount of school principals (or directors) 8, total amount of professors 7 and total amount of students 12 that are registered in the platform.

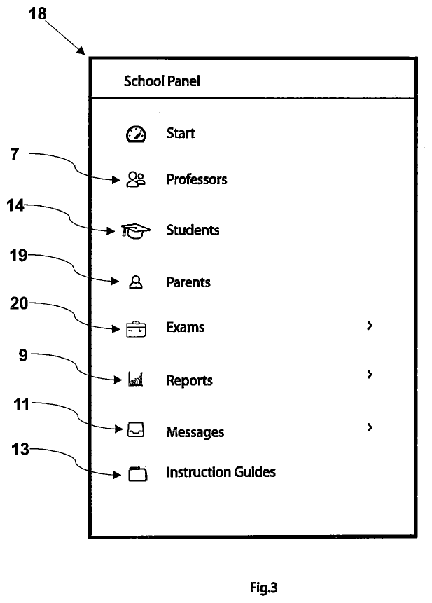

FIG. 3 Shows the school panel 18 for the school principal 8 of the school 5 that is registered within the platform. The school principal 8 has access to the professors 7, students 14, parents 19, the exams menu panel 20, reports 9, messages 11 and study materials 13, which may include instructional guides. The school principal 8 can provide easy communication between the professors 7, students 14 and parents 19, though chats and messages 11.

FIG. 4 shows the professor portal 18. the professor 7 has access to the students 14, study material 13 that will be provided to the students. The professor can administer, grade, create and/or modify exams, can communicate via messages 11 with parents 19 and/or students 14, can schedule exams and/or other related events in the calendar 12 to which students 14 also have access, and can create reports 9 based on the students' achievement. The professor portal also comprises a dashboard 22 that shows the total amount of grades 23, groups 24, students 14 and impact exams 4 that the professor 7 administers. It also comprises a graph 25 showing the number of students 14 per group 24 per grade 23 and a table 26 showing the status of exams for each group (e.g., the number of exams that have not been started, the number of exams that have or have not been corrected or evaluated).

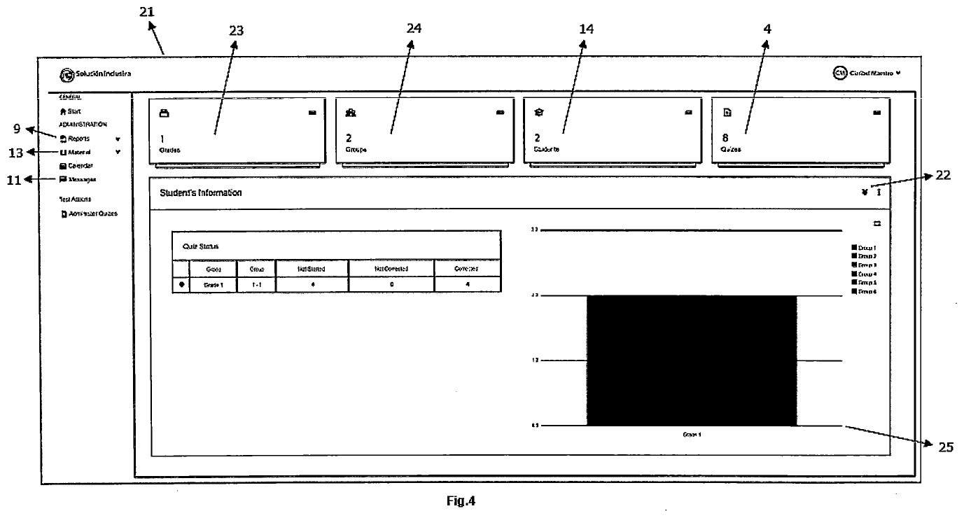

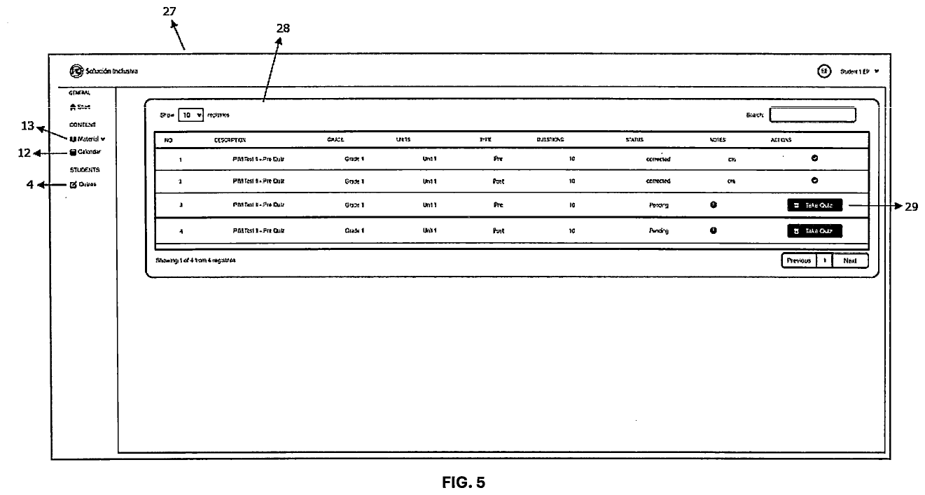

FIG. 5 shows the student portal 27. The student portal 27 gives access to the students 14 to their professors 7, parents 19, impact exams (quizzes) 4 and study material 13. The students 14 may view their scheduled exams in the calendar 12, and they may also schedule their own study time and/or related events. The student portal 27 also comprises a table 28 that shows the list of exams, the applicable learning unit, the number of questions per test, status of the test and percentage assigned upon evaluation or grading of the exam. If an exam is pending to be completed the student can press the button 29 to take the pending exam.

FIG. 6 shows the parent panel 30. the parents 19 can have access to their children (the students) 14, the professors 7, their children's grades, study material 13 and can communicate with professors 7 or school administrative staff through messages 11.

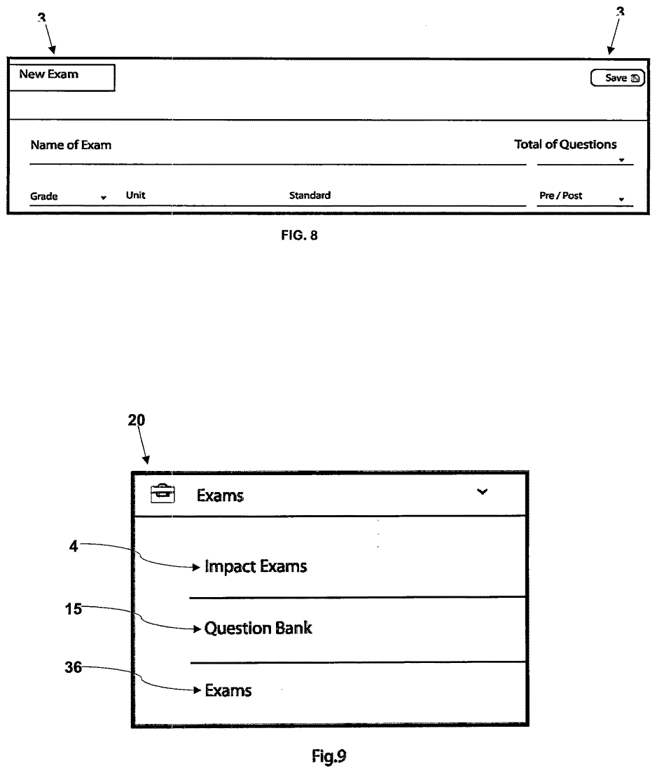

FIG. 7 shows impact exams list 31. The impact exams list 31 displays information about the available exams, such as, the name of the exam, the unit and corresponding standards that will be evaluated, the number of questions, the grade for which the exam was created, the type of test (e.g., post-test or pre-test) and action to take regarding the exam (e.g., view the exam, grade the exam or erase the exam). Using the search bar 32, the professor may search for a specific exam by inserting any of the aforementioned information. By pressing the “Add” button 33, the professor may create new exams, as shown in FIG. 8.

FIG. 8 shows the new exams page 34 for the professor to create exams. The professor can determine and insert the name of the exam, the unit and corresponding standards that will be evaluated, the number of questions, the grade for which the exam was created and the type of test (e.g., post-test or pre-test). Once the questions are chosen and the aforementioned information is entered, the professor may press the “Save” button 35 to save and create the new exam.

FIG. 9 shows a drop-down list categorizing information about the exams. When selecting the “Exams” button 20 in the menu panel, the users that have this function available will be able to toggle between Impact Exams 4, Question Bank 15 and Exams 36. The Impact Exams 4 are the standardized tests aligned to particular standards and unit. It is a functionality that allows the teacher to create tests to validate the knowledge of the students (or some of them) in some concept or skill before taking the standardized test. It is an alternative to build other non-standardized tests by concept, skill or standard.

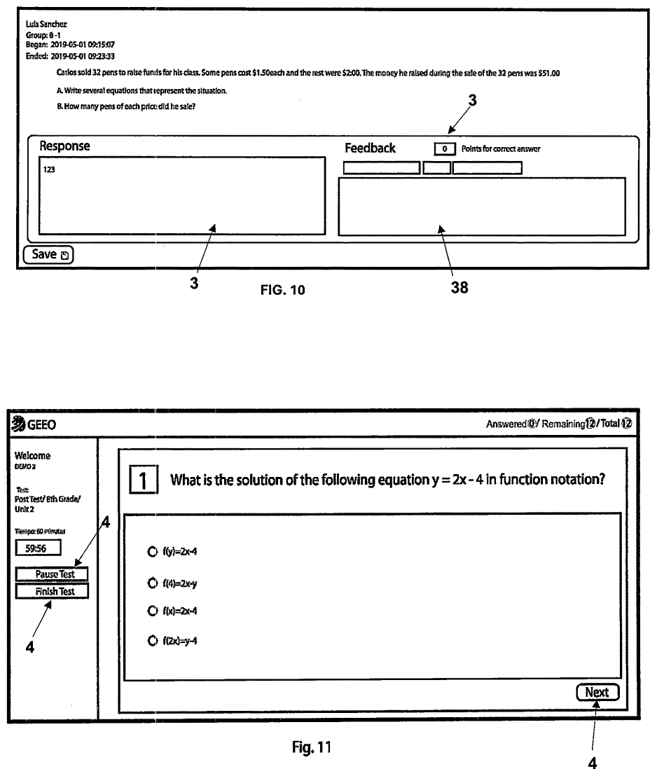

FIG. 10 shows how a professor grades and gives feedback to the student's open responses. The open responses include a response text box 37 in which the students will insert their responses to the open question shown above the response. When the professor is grading the response a “Feedback” section will be shown beside the “Response” section that includes a grading box 39 to insert the points awarded to the response and a feedback text box 38, to include the professor's feedback if the response is incorrect.

FIG. 11 shows how an exam is administered to the student. In the left margin, the student will see the name of the exam, which includes if it is a post-test or a pre-test, the unit and grade the exam corresponds to, the time provided to answer the exam and a timer clock showing the estimated time remaining, a “Pause Test” button 40 to pause the exam and a “Finish Test” button 41 to finish and turn in the exam. The top right corner of the screen shows the number of answered questions, the number of remaining questions that have not been answered and the total of questions in the exam. The student will be able to see only one question at a time and will be able to move forward and backward between questions by using buttons 42 that will allow the student to navigate between the next and previous questions.

FIG. 12 shows how the platform gives feedback to the student's 14 closed responses. If the student answers correctly, the feedback will state that the answer is correct. If the student answers incorrectly, the feedback will state why the student 14 might have chosen an incorrect answer or why the answer is incorrect, and which is the correct answer and why. The feedback may be provided automatically by storing in a relational database explanations for potential incorrect answers that are prompted when an incorrect answer is submitted by the student 14 or they might be added manually by the professor 7. If the student 14 did not answer the question, it will trigger a response stating that the student 14 did not answer.

For example, FIG. 12 shows a conceptual error in a math question product of an incorrect assumption. In that case, the platform will automatically provide an explanation to the student as to the incorrect assumption that was made, why that assumption was incorrect and the assumption that must be made to achieve a correct answer. In this example, the student 14 performed the incorrect mathematical operation and the platform, identifies said incorrect result which prompts the corresponding explanation related to the incorrect response in the database. This is essential for the student's knowledge development because it helps the student 14 understand the concept and theoretical foundation behind the answer, beyond the mechanical procedure, when developing the answer. Therefore, providing clarity as to the student's deficiency in the theoretical foundation that causes the student 14 to make mistakes in the mechanical procedure.

FIG. 13 shows a drop-down list for the multiple available reports. When the user selects the “Reports” button 9 from the menu panel, the program will show a variety of criteria by which the reports 9 can be issued, such as, by standard, by students, by groups, by units, by standard per student, by skills per student and by group standard.

FIG. 14 shows the reports by standard for a specific unit. The report 9 is in table format and displays the school, grade and unit for which it is being issued. It includes a column for the students that have taken exams for each of the standards 43 a-e within that unit and includes columns for the students'pre-test and post-test grades corresponding to each standard 43 a-e within said unit.

FIG. 15 shows the reports by student for a specific group. The report 9 is in table format and shows the school, grade and group for which it is being issued. The table shows a comparison between the points obtained in the pre-test as opposed to the post-test for each student within the specific group.

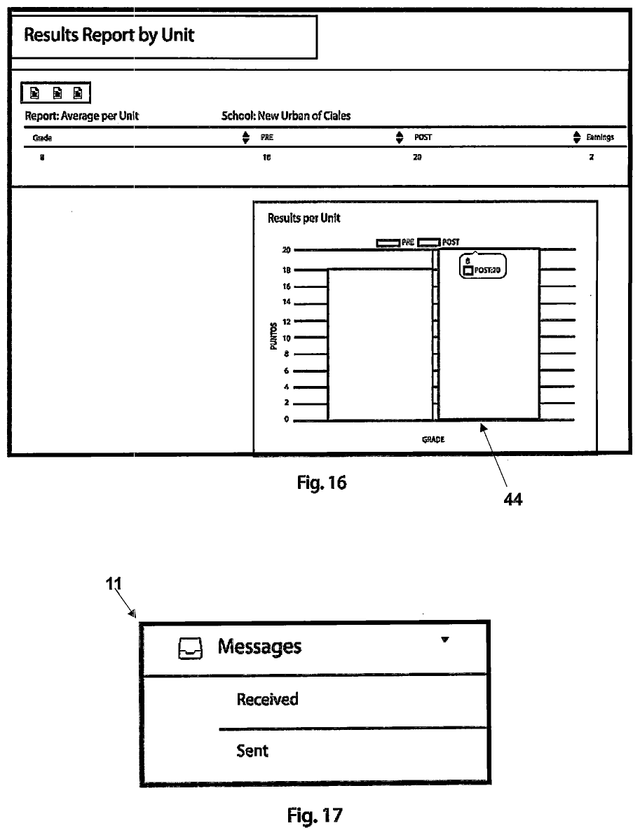

FIG. 16 shows the reports by unit per grade. The report 9 displays a table and interactive graph 44 comparing the results of the pre-test and post-test for a specific grade.

FIG. 17 shows a drop-down list to toggle between sent and received messages within the platform. When selecting the “Messages” button 11, the user can toggle between the “Received” and “Sent” buttons from the drop-down list to view the chats and/or messages that have been received and/or sent.

FIG. 18 shows the messages page within the platform. When selecting the “Sent” or “Received” buttons, the user may see a list of all the chats and the sent or received massages within the platform, the user that has sent or received the message, a description of the subject of the message and the date and time at which the message was sent or received. If the user selects a chat 45 from the list, the user will see the content of the message that was sent or received, and a text box will appear for the user to compose and send a response to said message.

FIG. 19 shows the calendar page within the platform. The calendar 12 includes a monthly view, a weekly view and a daily view. It allows the user to create and schedule an event and categorize it.

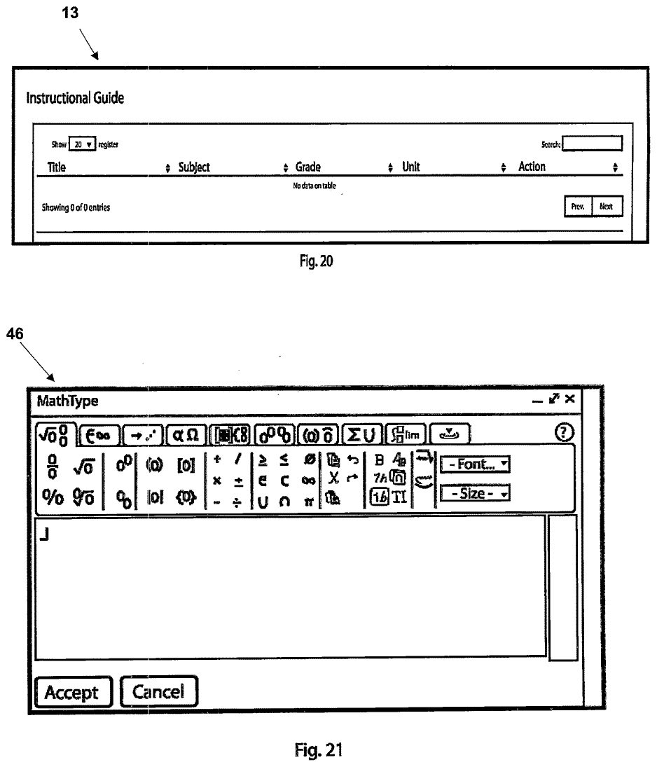

FIG. 20 shows the instructional guides available on the platform. When selecting the “Material” button 13 from the main menu, the professor 7 will view a list of all instructional guides available by title, subject, grade and unit. The professor 7 will be able to access each instructional guide in the platform.

FIG. 21 shows the response processor 46 for open responses. The response processor 46 will be available for the mathematics and science questions where an open response is required. The response processor 46 includes a text box, as well as symbols, equations, and other tools the student may need in order to submit a response to the question. The student may also modify the font and size of the text. Once the student is satisfied with the response, the “Accept” button will record the response and the “Cancel” button will discard it.

FIG. 22 shows a flowchart of the parallel processes performed by the system on the platform. All students 14 are evaluated using the impact exams 4 as a pre-test (Step 1). Once all students 14 are evaluated, the platform will provide the reports 9 by standard for a specific unit for each student 14 (Step 2 a) and reports by student 4 for a specific group (Step 2 b). Based on the results from the reports 9 obtained for each standard for a specific unit, the platform will organize and develop the curriculum in accordance with the needs identified in the reports 9 for each student 14 by using the instruction guide and/or workbook (Step 3 a). The professor 7 will then readminister the impact exams 4 after each instructional section has been completed as a post-test and the platform will adjust the group instruction according to the results obtained from the post-test (Step 4 a). Based on the reports 9 obtained for each student 14 for the specific group, the platform will recommend specific sections of the workbook to address the needs for the group identified in the reports 9 for the specific group (Step 3 b). The professor 7 will readminister the impact exams 4 as a post-test and the platform will provide individualized instruction for each student 14 according to the results obtained from the post-test (Step 4 b).

FIG. 23 shows an example of a rubric 47 that students 14 can access when answering questions related to a specific topic or skill. In this example, the rubric 47 relates to a function graph. In the rubric, students 14 are appraised of the criteria 48 that is being evaluated when answering questions related to a specific topic or skill. For all criteria 48, the rubric 47 shows the concepts 49 that the student 14 must master in order to master the applicable skill. A score 50 is assigned to the different levels of mastery that the student shows for all criteria 48, when answering the applicable questions.

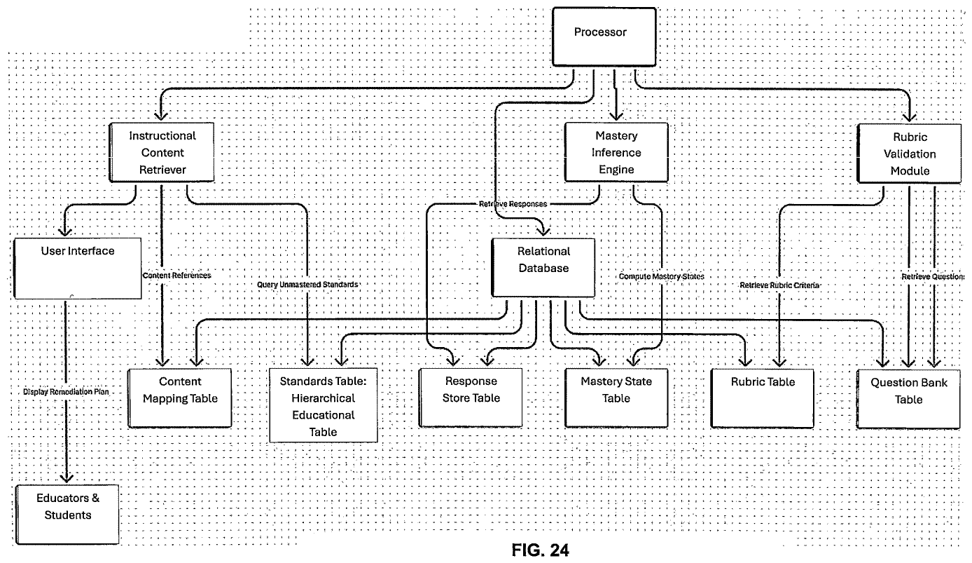

In one embodiment, shown in FIG. 24, the digital platform is implemented as a computer-implemented educational evaluation system comprising a processor, a relational database, a response store, and software-executed modules including a mastery inference engine, a rubric-validation module, and an instructional-content retriever. Each of these components is implemented as a machine-processed subsystem defined by a specific data structure and interaction pattern. The relational database is structurally configured to store test questions mapped to a machine-readable standards/skills graph. The graph comprises nodes that represent hierarchical educational elements, including (i) standards, (ii) sub-skills, and (iii) lesson units. Each node is implemented as a record in a “Standards” table containing unique identifiers (standard-ID), descriptors, grade-level metadata, and parent-child relationships between standards, sub-skills, and lessons. The unique identifier may be a string or alphanumeric code such as “STD-MATH-5.NBT.B.5,” which uniquely identifies the educational standard titled “Fluently multiply multi-digit whole numbers using the standard algorithm.” The “descriptor” field may store a human-readable summary of the standard or skill, for example, “Multiply three-digit numbers by two-digit numbers using regrouping.” The “grade-level metadata” field may include structured attributes such as {grade: 5, subject: “Mathematics,” curriculum_year: 2025}, which enable the system to classify the standard according to educational level and subject area. The “parent-child relationship” is implemented through a “parent_ID” field that references another record within the same Standards table, thereby defining the hierarchy among records. For example, a record for the sub-skill “Perform two-digit by two-digit multiplication with regrouping” may include a parent_ID that points to the standard record “STD-MATH-5.NBT.B.5.” Similarly, a lesson unit such as “Lesson 3.2: Multiplication Practice with Real-World Word Problems” may include a parent_ID pointing to the sub-skill record it supports. This structural configuration allows the processor to execute recursive queries or relational joins on the parent_ID field to automatically retrieve all sub-skills or lessons associated with a given standard, enabling deterministic machine traversal of the educational hierarchy without manual cross-referencing.

Edges between these nodes represent the logical relationships connecting educational standards, sub-skills, and lesson units, and are structurally implemented as entries in a “Mapping” table, each keyed by a unique question identifier (question-ID). Each question-ID acts as a foreign key linking a record in a “Question Bank” table to one or more records in the “Standards” table and, through additional foreign key associations, to the corresponding sub-skills and lesson units. In one embodiment, the Mapping table includes fields such as (question_ID, standard_ID, subskill_ID, lesson_ID), where each record defines a distinct association between a test question and the educational objectives it measures. For example, a question_ID “Q-50321” stored in the Question Bank may be linked to standard_ID “STD-MATH-5.NBT.B.5,” subskill_ID “SS-5.NBT.B.5A,” and lesson_ID “L-5.MATH.3.2,” indicating that the question evaluates multiplication skills associated with Lesson 3.2 in the fifth-grade mathematics curriculum. The Mapping table may also include a weight or difficulty field that stores a numeric value (e.g., 0.8 for high difficulty) to allow the system to differentiate between foundational and advanced assessment items. Each record in the Mapping table therefore serves as a machine-readable representation of the logical edge between a question and the hierarchical educational nodes it assesses. This structure enables the processor to execute structured query language (SQL) joins or equivalent traversal logic to retrieve all questions associated with a specific standard or sub-skill, or conversely, to identify which standards and lessons are evaluated by a given question. In other words, the Mapping table provides the technical mechanism by which question-to-standard relationships are defined and maintained automatically within the database schema, ensuring that all associations are deterministically processed by the machine rather than manually interpreted by users.

The relational database further includes a response store implemented as a persistent storage table optimized for write operations. Each record in the response store corresponds to an individual student response and includes a data tuple comprising a student identifier (student-ID), question identifier (question-ID), response outcome, timestamp, and correctness indicator. For example, a record may include student-ID STU-10023, question-ID Q-50321, response outcome 42 (for a numeric answer) or B (for a multiple-choice answer), timestamp 2025-10-28T14:32:10Z, and correctness indicator 1 (indicating a correct response). In other words, each row in the response store captures a specific, machine-recorded interaction between a student and a test item, preserving both identification and temporal data necessary for automated analysis. The response store maintains indexed columns on student-ID and question-ID to support efficient retrieval of all responses associated with a given student or question. In other words, the database architecture is designed to enable the processor to execute indexed queries and data joins rapidly, allowing automated computation of summary statistics without human intervention. This structural configuration allows the processor to compute performance metrics, mastery states, and frequency distributions of incorrect answers across groups or grades in real time through executable database instructions, rather than through manual or mental review.

The mastery inference engine is a software-executed module stored in memory and executed by the processor. It retrieves data from the response store and applies a deterministic algorithm to compute a mastery state for each student across standards and sub-skills. In particular, the deterministic algorithm comprises the following steps: (i) retrieving all recorded responses for a given student and standard or sub-skill, (ii) applying a weighted aggregation formula that assigns weights to each response based on multiple test administrations and recency of submission, (iii) computing an accuracy ratio based on the number of correct versus incorrect responses, and (iv) comparing the resulting weighted score to predefined threshold values stored in the database to assign a mastery classification such as “mastered,” “near-mastery,” or “not-comprehended.” In one embodiment, the engine applies this weighted aggregation formula to ensure that the same set of input responses always produces the same mastery classification. The computed mastery results are stored in a Mastery State table of the relational database. Each record in the Mastery State table includes a student identifier (student-ID), a standard identifier (standard-ID), a mastery level, and a timestamp indicating when the mastery state was computed. For example, a record in the Mastery State table may include student-ID STU-10023, standard-ID STD-MATH-5.NBT.B.5, mastery-level mastered, and timestamp 2025-10-28T15:45:00Z. Another example might include student-ID STU-10024, standard-ID STD-MATH-5.NBT.B.5, mastery-level not-comprehended, and timestamp 2025-10-28T15:50:00Z. These records allow the processor to track each student's mastery over time, compute group-level summaries, and generate automated remediation plans for standards or sub-skills classified as not-comprehended. The Mastery State table is indexed on student-ID and standard-ID to support efficient querying and automated computation without human intervention. In other words, the mastery inference engine functions as an executable computation module that retrieves structured numerical data from indexed tables, performs machine-implemented statistical operations on that data, and updates a persistent database table with the resulting mastery classifications. The process is entirely computer-driven, relying on stored algorithms and programmed logic rather than human interpretation or judgment. In one embodiment, the relational database further includes a “Rubric” table that stores numeric weighting parameters, scoring formulas, and threshold values used by the rubric-validation module. Each rubric record may include fields such as (criterion-ID, criterion-name, weight, threshold, descriptor), allowing the module to retrieve and apply these stored values deterministically during the question evaluation process. For example, a criterion-ID “CR-ALIGN-01” may correspond to “Alignment with Standard,” with weight=0.9, threshold=0.75, and descriptor=“Question measures the intended learning standard.” These stored rubric values are accessed programmatically during the item-quality computation process executed by the module.

The rubric-validation module is a database-driven assessment engine operatively coupled to the processor and relational database. It retrieves question data from the Question Bank table and evaluates the quality of each question against a stored rubric table containing weighted scoring factors such as alignment, cognitive level, clarity, and distractor quality. For each question, the module computes a composite item-quality score (S=w₁·align+w₂·cognitive+w₃·clarity+w₄·distractors) and compares the result to a rubric threshold value (R_min) stored in the database. The threshold value R_min defines the minimum acceptable quality score for a question to be considered publishable; for example, if R_min=0.75 on a normalized scale, any question with a computed score below this value is automatically rejected by the system. Questions scoring below R_min are automatically flagged by setting a binary “publish flag” field to false, and their evaluation results are stored in an “Item Quality Log” table for later review by teachers or administrators. In other words, the rubric-validation module operates as a structured data-processing subsystem that executes programmed arithmetic operations on rubric parameters stored in relational tables, writes the resulting computed values to a persistent log, and programmatically updates control fields associated with each question record. This ensures that the evaluation process is machine-implemented and repeatable, relying on database logic and processor-executed calculations rather than subjective human grading or interpretation.

The instructional-content retriever is implemented as a database access layer and retrieval process executed by the processor. It uses a versioned mapping table that links each standard-ID and subskill-ID to corresponding workbook sections and instructional guide pages. When a student or group is identified as lagging in a particular skill, the retriever performs a parameterized query over the mapping table to obtain content identifiers (e.g., document-ID, section-ID, page reference) and compiles these results into a machine-readable remediation plan. The retrieved content references are transmitted to a user interface for display to teachers and students as part of a recommended reinforcement plan. In other words, the instructional-content retriever functions as a structured data-access subsystem that executes programmed database queries to resolve cross-references between learning objectives and instructional materials. The instructional-content retriever's operation is defined by table schemas and query parameters stored in memory, ensuring that the association and retrieval of content are performed automatically through database logic rather than by manual selection or subjective human judgment. This architecture provides a concrete technical mechanism for generating remediation outputs directly from structured relational data.

In one embodiment, the user interface is implemented as a graphical analytics layer of the digital platform, configured to receive and display outputs generated by the instructional-content retriever and mastery inference engine. The interface renders mastery visualizations such as charts, skill maps, and heatmaps; displays instructional content references retrieved from the database; and allows educators to view remediation plans generated by the system. The user interface may be web-based, tablet-based, or integrated within a learning management system (LMS), and is operatively coupled to the processor to enable dynamic updates from stored query results. This structure ensures that all visualizations and content recommendations are generated and displayed through defined data pipelines, rather than manual compilation.

All of the foregoing components—namely, the relational database, response store, mastery inference engine, rubric-validation module, and instructional-content retriever—operate together as a computer-implemented system that transforms educational assessment data into structured, actionable information. The use of defined tables, keys, and computational modules ensures that the system's operations are rooted in computer technology and implemented by specific machine structures, rather than generic manual or cognitive processes.

The mastery inference engine, executed by the processor, computes a mastery state per student by aggregating response outcomes across test administrations, applying recency weighting and threshold parameters (T_mastery, T_risk) stored in the database. Each standard or sub-skill is classified as mastered, near-mastery, or not-comprehended. The inference engine stores the computed mastery states in a tracking table linked by student-ID and standard-ID to facilitate longitudinal analysis and group-level summaries. In other words, the mastery inference engine is a software-implemented computation module that applies a defined algorithm to structured data fields in the response store. The mastery inference engine uses deterministic formulas stored in memory, such as weighted averages, decay functions, and threshold comparisons, to produce objective, reproducible mastery classifications. By writing the resulting mastery states into a structured tracking table, the system ensures that student performance metrics are generated and updated through programmable, rule-based computation rather than qualitative evaluation, thereby providing a concrete technical mechanism for real-time data processing and analysis.

The system also comprises a rubric-validation module implemented as a database-driven assessment component configured to automatically evaluate teacher-authored or system-generated test questions before they are deployed. The rubric-validation module is a database-driven assessment engine operatively coupled to the processor and relational database. It retrieves question data from the Question Bank table and evaluates the quality of each question against stored rubric criteria. In one embodiment, the rubric criteria comprise one or more weighted numeric attributes such as alignment with learning objectives (weight w1), cognitive level (weight w2), clarity (weight w3), and distractor quality (weight w4). For example, a question may have rubric criteria values of alignment=0.9, cognitive level=0.8, clarity=0.95, and distractor quality=0.85. The module computes an item-quality score (S) for each question using a defined arithmetic formula, such as a weighted sum: S=w1*alignment+w2*cognitive+w3*clarity+w4*distractors. For the example values above, the computed score would be S=0.9*0.9+0.8*0.8+0.95*0.95+0.85*0.85=3.2 (numeric example for illustration purposes). Once the item-quality score is computed, it is compared to a stored threshold value (R_min) in the database. The “publish-flag” field is a binary control field in the Question Bank table that determines whether a question is approved for use in assessments. For instance, a publish-flag value of 1 indicates the question is approved for publication, whereas 0 indicates it is not approved. If the item-quality score S falls below the threshold R_min, the rubric-validation module automatically sets the publish-flag to 0 and writes an audit log entry in the Item Quality Log table. This ensures that only questions meeting the predefined quality criteria are made available for assessments. The computation of S, the comparison to R_min, and the update of the publish-flag are all deterministic operations, meaning that the same question data will always produce the same item-quality score and flag status.

The instructional-content retriever is a programmatic component operatively coupled to the relational database and configured to retrieve references to workbook sections or instructional guide pages corresponding to standards or sub-skills classified as not-comprehended. The retriever queries a versioned mapping table linking each standard-ID to specific content locations, thereby generating a machine-readable remediation plan associating each lagging skill with targeted instructional content. In one embodiment, the mapping table includes fields such as (standard-ID, subskill-ID, lesson-ID, document-ID, section-ID, page-reference), where each record defines a specific correspondence between an educational objective and a content resource. For example, a record may link standard-ID “STD-MATH-5.NBT.B.5” (Fluently multiply multi-digit whole numbers using the standard algorithm) and subskill-ID “SS-5.NBT.B.5A” (Perform two-digit by two-digit multiplication) to document-ID “DOC-1023,” section-ID “Sec-3.2,” and page-reference “p.45-47” of a mathematics workbook. When the mastery inference engine classifies a sub-skill as “not-comprehended” for a student (e.g., student-ID “STU-10023”), the retriever performs a parameterized SQL query over the mapping table using that student's mastery data to identify the linked instructional materials. The query result may return a set of document and section identifiers corresponding to lessons relevant to the deficient skill. The retrieved results are then compiled into a structured remediation plan comprising tuples such as (student-ID, standard-ID, subskill-ID, document-ID, section-ID, page-reference), which are stored in a temporary remediation output table. The results of this retrieval are displayed to users through a role-based analytics interface that also presents a standards/skills mastery map per student, per group, or per class, including longitudinal progress charts generated by the inference engine. In other words, the instructional-content retriever operates as a structured database access layer that uses stored key relationships (such as standard-ID, subskill-ID, and document-ID) to locate relevant instructional resources. Each retrieval operation is deterministic—given the same set of input parameters (student-ID, standard-ID, subskill-ID), the system will always return the same content references because the relationships are defined by fixed foreign-key mappings rather than heuristic text matching. The retriever executes deterministic query logic using parameterized SQL statements or equivalent API calls, ensuring that each retrieved content reference corresponds to a uniquely identified section of a versioned resource. This ensures that remediation content is programmatically generated through the database schema and query logic, rather than selected manually or inferred conceptually by human users. By transmitting these results to a graphical analytics interface, the system implements a technical pipeline for structured data retrieval, transformation, and visualization, rather than a conceptual matching of topics.

In another embodiment, the rubric-validation module prevents publication of items whose quality score falls below the rubric threshold (S<R_min) by disabling their publish flag in the database and recording the failed criteria in the audit log. The analytics interface can render graphical heatmaps and progression charts showing mastery transitions per student, thereby allowing educators to monitor student growth with precision over multiple administrations. In other words, the rubric-validation module's publish-control mechanism is implemented through database flag fields and audit-log entries that are automatically updated by stored procedures or background tasks, ensuring deterministic enforcement of publication policies. The analytics interface is technically realized as a visualization layer driven by structured query outputs, where heatmaps and charts are generated through programmatic data aggregation and rendering functions rather than interpretive analysis. Together, these modules demonstrate a concrete data-processing architecture that produces measurable system outputs using defined data structures and executable instructions.

In summary of the previous sections, the disclosure presented here is structurally innovative, presents advantages not available at the moment, complies with all new patent application requirements and is hereby lawfully submitted to the patent bureau for review and the granting of the commensurate patent rights.

While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

What is claimed is:

1. A computer-implemented educational evaluation system, comprising:
a processor;
a relational database operatively coupled to the processor, the relational database comprising:
a Standards table storing a hierarchical educational graph, the educational graph comprising a plurality of nodes, wherein each node represents a standard, sub-skill, or lesson unit, and is stored as a record having at least one of a unique identifier, descriptor, grade-level metadata, and parent-child relationship implemented as a foreign key reference linking the record to another node in the hierarchical educational graph;
a Question Bank table storing test questions, each question linked via foreign keys to one or more nodes of the hierarchical educational graph to define question-to-standard mappings; and
a Response Store table storing student responses, each response comprising a student identifier, question identifier, response outcome, timestamp, and a correctness indicator;
a mastery inference engine stored in memory and executed by the processor, the mastery inference engine configured to:
retrieve student responses from the Response Store table, and
compute, for each student, a mastery state for each standard and sub-skill by applying a deterministic algorithm comprising weighted aggregation of multiple test administrations, recency weighting, and threshold comparisons, and
store the computed mastery states in a Mastery State table of the relational database;
a rubric-validation module stored in memory and executed by the processor, the rubric-validation module configured to:
retrieve question records from the Question Bank table and rubric criteria from a Rubric table of the relational database, each criterion stored as a weighted numeric value;
compute an item-quality score for each question by applying a defined arithmetic formula to the stored numeric rubric criteria;
compare the computed item-quality score to a stored threshold value, and
update a publish-flag field in the Question Bank table and store an audit log entry for questions failing to meet the threshold;
an instructional-content retriever stored in memory and executed by the processor, the instructional-content retriever configured to:
query the relational database to identify instructional content associated with standards or sub-skills classified as not-comprehended for a student or group of students;
retrieve references to the instructional content from versioned mapping tables linking standards and sub-skills to specific content identifiers; and
generate a machine-readable remediation plan comprising the retrieved content references and provide the generated remediation plan to a user interface for display to educators and students.

2. The system of claim 1, wherein the Response Store table maintains indexed columns on student-ID and question-ID to support efficient retrieval of all responses associated with a given student or question.

3. The system of claim 1, wherein the mastery inference engine applies a weighted aggregation formula that assigns higher weights to more recent test responses.

4. The system of claim 1, wherein the mastery inference engine classifies each standard or sub-skill into one of three mastery levels, including “mastered,” “near-mastery,” and “not-comprehended.”

5. The system of claim 1, wherein the rubric-validation module computes an item-quality score according to the formula S=w₁·align+w₂·cognitive+w₃·clarity+w₄·distractors, where w₁-w₄ are weighting coefficients stored in the relational database.

6. The system of claim 5, wherein the rubric-validation module sets a publish-flag field to false for any question whose computed item-quality score is below a stored threshold value R_min.

7. The system of claim 6, wherein the rubric-validation module stores failed evaluation results in an Item Quality Log table for later review by educators or administrators.

8. The system of claim 1, wherein the descriptor field of each record stores a human-readable summary of the standard or skill, including a textual explanation.

9. A computer-implemented method for evaluating and improving student learning performance, executed by a processor operatively coupled to a relational database, the method comprising:
storing, in the relational database, a hierarchical educational graph in a Standards table, the hierarchical educational graph comprising a plurality of nodes, wherein each node represents a standard, sub-skill, or lesson unit, and each node is stored as a record having at least one of: (a) a unique identifier;
(b) a descriptor;
(c) grade-level metadata; and
(d) a parent-child relationship implemented as a foreign key reference linking the record to another node in the hierarchical educational graph;
storing, in a Question Bank table of the relational database, a plurality of test questions, each test question linked via foreign keys to one or more nodes of the hierarchical educational graph to define question-to-standard mappings;
recording, in a Response Store table of the relational database, student response data, each record comprising a student identifier, question identifier, response outcome, timestamp, and correctness indicator;
retrieving, by a mastery inference engine executed by the processor, student response data from the Response Store table;
computing, by the mastery inference engine, for each student, a mastery state for each standard and sub-skill by applying a deterministic algorithm comprising weighted aggregation of multiple test administrations, recency weighting, and threshold comparisons;
storing, by the mastery inference engine, the computed mastery states in a Mastery State table of the relational database;
retrieving, by a rubric-validation module executed by the processor, question records from the Question Bank table and rubric criteria from a Rubric table of the relational database, each rubric criterion stored as a weighted numeric value;
computing, by the rubric-validation module, an item-quality score for each question by applying a defined arithmetic formula to the stored numeric rubric criteria;
comparing, by the rubric-validation module, the computed item-quality score to a stored threshold value;
updating, by the rubric-validation module, a publish-flag field in the Question Bank table and storing an audit log entry for each question failing to meet the threshold, thereby automatically controlling the publication of test items based on the computed score;
querying, by an instructional-content retriever executed by the processor, the relational database to identify instructional content associated with standards or sub-skills classified as not-comprehended for a student or group of students;
retrieving, by the instructional-content retriever, references to the instructional content from versioned mapping tables linking standards and sub-skills to specific content identifiers; and
generating, by the instructional-content retriever, a machine-readable remediation plan comprising the retrieved content references and providing the generated remediation plan to a user interface for display to educators and students.
